(19) United States
(12) Patent Application Publication
(10) Pub. No.: US 2024/0037722 A1
(43) Pub. Date: Feb. 1, 2024

(54) ELECTRONIC DEVICE FOR ENCODING VIDEO, AND CONTROL METHOD THEREFOR

(71) Applicant: SAMSUNG ELECTRONICS CO., LTD., Suwon-si (KR)

(72) Inventors: Sanguk PARK, Suwon-si (KR); Bongsoo JUNG, Suwon-si (KR); Seonghwan KIM, Suwon-si (KR); Donghyun YEOM, Suwon-si (KR)

(21) Appl. No.: 18/380,130

(22) Filed: Oct. 13, 2023

Related U.S. Application Data
(63) Continuation of application No. PCT/KR2022/003609, filed on Mar. 15, 2022.

(30) Foreign Application Priority Data
Apr. 15, 2021 (KR) 10-2021-0049179

(51) Int. Cl. G06T 5/00; G06T 5/40

(52) U.S. Cl. CPC G06T 5/009; G06T 5/40; G06T 2207/20208; G06T 2207/10016

(57) ABSTRACT

According to various embodiments, an electronic device includes at least one camera and at least one processor. The processor is configured to acquire, through the at least one camera, a first video of which the maximum luminance is a first luminance, check a first tone mapping function for converting the first video into a second video of which the maximum luminance is a second luminance that is lower than the first luminance, and check a second tone mapping function for converting the first video into a third video of which the maximum luminance is a third luminance that is lower than the second luminance. The processor is configured to relate, to the first video, first metadata based on the first tone mapping function and second metadata based on the second tone mapping function and store same.

### CROSS-REFERENCE TO RELATED APPLICATIONS

This application is a continuation of International Application No. PCT/KR2022/003609 designating the United States, filed on Mar. 15, 2022, in the Korean Intellectual Property Receiving Office and claiming priority to Korean Patent Application No. 10-2021-0049179, filed on Apr. 15, 2021, in the Korean Intellectual Property Office, the disclosures of each of which are incorporated by reference herein in their entireties.

### BACKGROUND

Various embodiments relate to an electronic device for encoding a video and a method of controlling the same.

HDR10+ is an HDR format supporting rendering using dynamic metadata and is described in a technical document of SMPTE 2094-40. An electronic device capturing an HDR10+ video through a camera may analyze characteristics of an image for each frame, generate a dynamic tone mapping function of HDR10+, and store metadata indicating the dynamic tone mapping function in an SEI user data space of an HEVC codec.

When the electronic device reproducing the HDR10+ video does not support maximum luminance of the HDR10+ video, the electronic device may parse the metadata stored in the SEI use data space to acquire the dynamic tone mapping function and perform tone mapping for the HDR10+ video on the basis of the dynamic tone mapping function in order to convert the HDR10+ video into a video having low maximum luminance. Further, the electronic device reproducing the HDR10+ video in the form of SDR may generate an SDR tone mapping function with reference to the dynamic tone mapping function and perform tone mapping for the HDR10+ video on the basis of the SDR tone mapping function.

An electronic device which reproduces an HDR10+ video in an SDR format may generate an SDR tone mapping function with reference to a dynamic tone mapping function and perform tone mapping for the HDR10+ video on the basis of the SDR tone mapping function. During a process of editing and sharing the HDR10+ video captured by a smartphone, the generation of the SDR tone mapping function may be frequently required. Further, when the number of frames of a video is large, the process of generating the SDR tone mapping function may require a large number of calculations.

### SUMMARY

An electronic device according to various embodiments may store first metadata indicating a first tone mapping function for converting a first video having a first luminance as the maximum luminance into a second video having a second luminance that is lower than the first luminance as the maximum luminance and second metadata indicating a second tone mapping function for converting the first video into a third video having a third luminance that is lower than the second luminance as the maximum luminance to be correlated with the first video.

An electronic device according to various embodiment includes at least one camera, and at least one processor, wherein the at least one processor is configured to acquire a first video through the at least one camera, wherein a maximum luminance of the first video is a first luminance, identify a first tone mapping function for converting the first video into a second video, wherein a maximum luminance of the second video is a second luminance that is lower than the first luminance, identify a second tone mapping function for converting the first video into a third video, wherein a maximum luminance of the third video is a third luminance that is lower than the second luminance, and store first metadata, which is based on the first tone mapping function and second metadata, which is based on the second tone mapping function to be correlated with the first video.

A method performed by an electronic device according to various embodiments includes acquiring a first video through at least one camera of the electronic device, wherein a maximum luminance of the first video is a first luminance, identifying a first tone mapping function for converting the first video into a second video, wherein a maximum luminance of the second video is a second luminance that is lower than the first luminance, identifying a second tone mapping function for converting the first video into a third video a third luminance that is lower than the second luminance, and storing first metadata, which is based on the first tone mapping function and second metadata, which is based on the second tone mapping function to be correlated with the first video.

An electronic device according to various embodiments includes a display and at least one processor, wherein the at least one processor is configured to acquire a first video and metadata related to the first video, wherein a maximum luminance of the first video is a first luminance, the metadata including first metadata indicating a first tone mapping function for converting the first video into a second video wherein a luminance of the second video is a second luminance that is lower than the first luminance and second metadata indicating a second tone mapping function for converting the first video into a video, wherein a maximum luminance of the video is a third luminance that is lower than the second luminance, identify the maximum luminance supported by the display and a function performed by an application of which an execution screen is displayed on the display, display the first video on the basis of the maximum luminance supported by the display and the function performed by the application, display the second video on the basis of the first tone mapping function, or display the video, wherein a maximum luminance of the video is the third luminance on the basis of the second tone mapping function.

According to various embodiments, an electronic device for encoding a video and a method of controlling the same are provided. An electronic device according to various embodiments may store first metadata indicating a first tone mapping function for converting a first video having a first luminance as the maximum luminance into a second video having a second luminance that is lower than the first luminance as the maximum luminance and second metadata indicating a second tone mapping function for converting the first video into a third video having a third luminance that is lower than the second luminance as the maximum luminance to be correlated with the first video. Since not only the first metadata but also the second metadata is stored to be correlated with the first video, the electronic device which decodes and reproduces the first video can identify a second tone mapping function by parsing the second metadata without a need to generate the second tone mapping function on the basis of a first tone mapping function, thereby converting the first video into the form having a low maximum luminance with a small amount of calculations.

The electronic device according to various embodiments stores third metadata indicating a frame corresponding to a scene change within the first video to be correlated with the first video, and thus the electronic device which decodes and reproduces the first video may use the same second tone mapping function for the same scene, thereby reducing power consumption.

### BRIEF DESCRIPTION OF DRAWINGS

The above and other aspects, features and advantages of certain embodiments of the present disclosure may be more apparent from the following detailed description, taken in conjunction with the accompanying drawings, in which:

FIG. 1 is a block diagram illustrating an electronic device within a network environment according to various embodiments.

FIG. 2 is a block diagram of an electronic device which encodes a video and an electronic device which decodes a video according to various embodiments.

FIG. 3 illustrates a flow diagram of operations performed by an electronic device which encodes a video according to various embodiments.

FIG. 4A illustrates first metadata and second metadata according to various embodiments.

FIG. 4B illustrates an example of a first tone mapping function according to various embodiments.

FIG. 4C illustrates an example of a second tone mapping function according to various embodiments.

FIG. 4D illustrates an example of the second tone mapping function according to various embodiments.

FIG. 5A illustrates an example of a method of generating the second tone mapping function according to various embodiments.

FIG. 5B illustrates an example of a method of generating the second tone mapping function according to various embodiments.

FIG. 6A illustrates an example of a method of simplifying the second tone mapping function according to various embodiments.

FIG. 6B illustrates an example of a method of simplifying the second tone mapping function according to various embodiments.

FIG. 7 illustrates a flow diagram of operations performed by an electronic device which encodes a video according to various embodiments.

FIG. 8 illustrates first metadata, second metadata, and third metadata according to various embodiments.

FIG. 9 illustrates a flow diagram of operations performed by an electronic device which decodes a video according to various embodiments.

### DETAILED DESCRIPTION

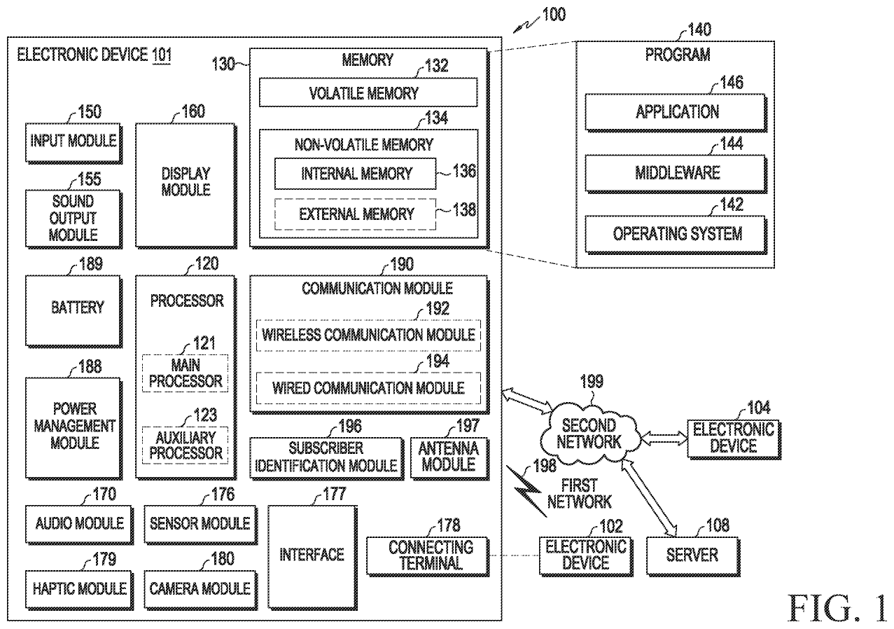

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

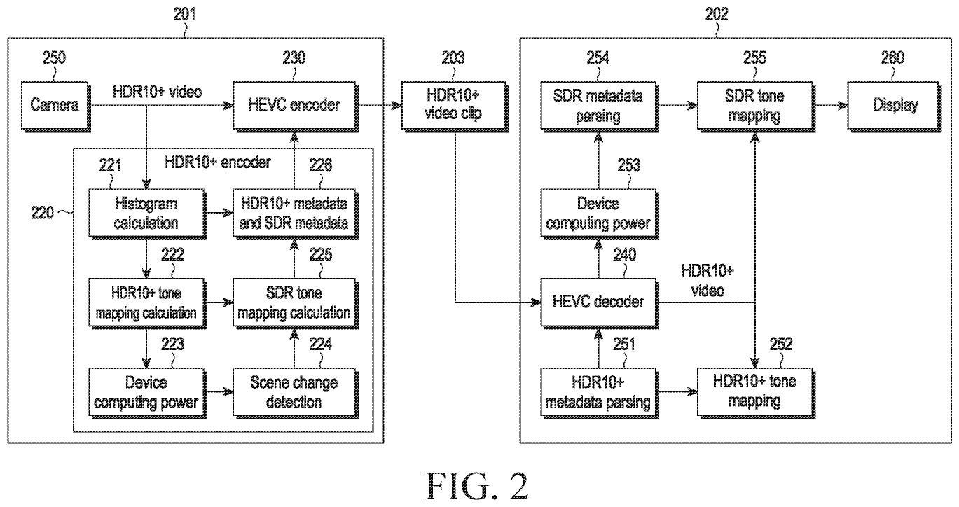

FIG. 2 is a block diagram of an electronic device 201 which encodes a video and an electronic device 202 which decodes a video according to various embodiments. According to various embodiments, an electronic device 201 (for example, the electronic device 101) may be an electronic device which encodes a video. According to various embodiments, the electronic device 201 may include a camera 250, an HDR10+ encoder 220, and an HEVC encoder 230.

According to various embodiments, the electronic device 201 may acquire an HDR10+ video through the camera 250. According to various embodiments, the HDR10+ video may have a first luminance as the maximum luminance. Although FIG. 2 illustrates only one camera 250, the electronic device 201 may include a plurality of cameras 250 according to various embodiments.

According to various embodiments, the HDR10+ encoder 220 may be implemented using at least one of a CPU of the electronic device 202, a GPU, a DSP, a camera ISP within an application processor, or a codec. In FIG. 2, a histogram calculation 221, an HDR10+ tone mapping function calculation 222, device computing power 223 (i.e., a number of instructions per second that a processor of the electronic device 201 can perform), scene change detection 224, an SDR tone mapping function calculation 225, and HDR10+ metadata and SDR metadata 226 within the HDR10+ encoder 220 indicate functions performed by the HDR10+ encoder 220.

According to various embodiments, the HDR10+ encoder 220 may perform the histogram calculation 221 for calculating a histogram having the maximum value among an R value, a G value, and a B value for a plurality of frames included in the HDR10+ video acquired through the camera 250. The histogram acquired through the histogram calculation 221 may be used to determine an amount of motion within the video in order to divide scenes included in the HDR10+ video.

According to various embodiments, the HDR10+ encoder 220 may perform the HDR10+ tone mapping function calculation 222 that derives the HDR10+ tone mapping function for converting the HDR10+ video having the first luminance as the maximum luminance into a video having a second luminance as the maximum luminance on the basis of the histogram. According to various embodiments, the second luminance may be lower than the first luminance. According to various embodiments, the HDR10+ tone mapping function may be defined individually for each of a plurality of frames included in the HDR10+ video.

According to various embodiments, the HDR10+ encoder 220 may identify the device computing power 223 of the electronic device 201. According to various embodiments, the HDR10+ encoder 220 may perform the scene change detection 224 on the basis of the histogram acquired through the histogram calculation 221. According to various embodiments, the HDR10+ encoder 220 may derive the correlation between frames on the basis of the histogram and categorize frames having a small change of motion into one scene on the basis of the correlation, so as to detect the scene change. According to various embodiments, the HDR10+ encoder 220 may generate scene metadata indicating frames, for example, first frames or last frames of scenes at a time point at which the scene is changed among the frames included in the HDR10+ video.

According to various embodiments, the HDR10+ encoder 220 may perform the scene change detection 224 in consideration of the device computing power 223. For example, when the device computing power 223 is low, even the frames having a large change of motion therebetween are categorized into one scene and thus the scene change detection 224 may be performed such that the number of scenes included in the HDR10+ video is small. When the device computing power 223 is high, even the frames having a small change of motion therebetween are categorized into different scenes and thus the scene change detection 224 may be performed such that the number of scenes included in the HDR10+ video is large.

According to various embodiments, the HDR10+ encoder 220 may perform the scene change detection 224 multiple times and generate a plurality of pieces of scene metadata corresponding to the plurality of scene change detections 224. The plurality of pieces of scene metadata may include scene metadata indicating that the number of scenes included in the HDR10+ video is relatively large and scene metadata indicating that the number of scenes included in the HDR10+ video is relatively small.

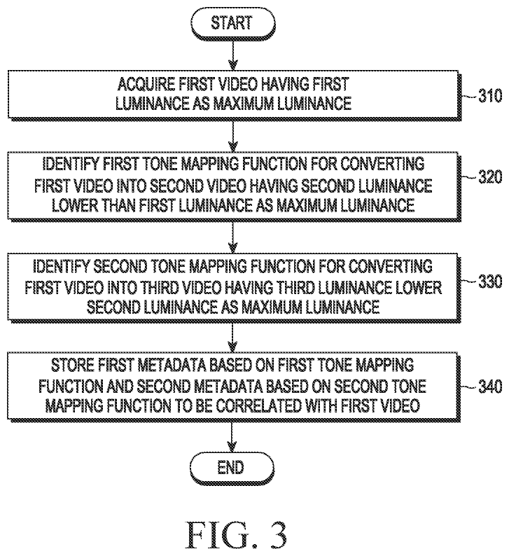

According to various embodiments, the HDR10+ encoder 220 may perform the SDR tone mapping function calculation 225 on the basis of the result of the HDR10+ tone mapping function calculation 222. The SDR tone mapping function calculation 225 may be a process of deriving the SDR tone mapping function for converting the HDR10+ video having the first luminance as the maximum luminance into an SDR video having a third luminance as the maximum luminance. According to various embodiments, the third luminance may be lower than the second luminance. The process of performing the SDR tone mapping function calculation 225 on the basis of the result of the HDR10+ tone mapping function calculation 222 is described below with reference to operation 330 of FIG. 3. According to various embodiments, the HDR10+ encoder 220 may identify a plurality of Bezier curves having different degrees for one frame as a plurality of SDR tone mapping functions.

According to various embodiments, the HDR10+ encoder 220 may perform the SDR tone mapping function calculation 225 in consideration of the device computing power 223. According to various embodiments, when the device computing power 223 is high, the HDR10+ encoder 220 may calculate the SDR tone mapping function with reference to the HDR10+ tone mapping function separately for all frames included in the HDR10+ video. According to various embodiments, when the device computing power 223 is low, the HDR10+ encoder 220 may calculate a representative SDR tone mapping function applied to frames included in the same scene with reference to the result of the scene change detection 224. According to various embodiments, the HDR10+ encoder 220 may identify a Bezier curve having a low degree as the SDR tone mapping function when the device computing power 223 is low, and identify a Bezier curve having a high degree as the SDR tone mapping function when the device computing power 223 is high.

According to various embodiments, the HDR10+ encoder 220 may generate HDR10+ metadata on the basis of the result of the HDR10+ tone mapping function calculation 222 and generate SDR metadata on the basis of the result of the SDR tone mapping function calculation 225. According to various embodiments, the HDR10+ metadata may indicate the HDR10+ tone mapping function for frames included in the HDR10+ video. According to various embodiments, the SDR metadata may indicate the SDR tone mapping function for frames included in the HDR10+ video.

According to various embodiments, the HDR10+ metadata and SDR metadata 226 may be stored in the SEI user data space of the HEVC codec when the HVEC encoder 230 performs HEVC encoding for the HDR10+ video. According to various embodiments, in addition to the HDR10+ metadata and SDR metadata 226, scene metadata may be stored in the SEI user data space of the HEVE codec.

An HDR10+ video clip 203 including the HDR10+ video, the HDR10+ metadata, and the SDR metadata may be stored in a memory (for example, the memory 130) of the electronic device 201.

According to various embodiments, the electronic device 202 (for example, the processor 120 of the electronic device 101) is an electronic device for decoding and reproducing the HDR10+ video and may be an electronic device which is the same as the electronic device 201. Alternatively, according to various embodiments, the HDR10+ video clip 203 may be transferred to the electronic device 202 separated from the electronic device 201.

According to various embodiments, the electronic device 202 may reproduce the HDR10+ video in different formats on the basis of the maximum luminance supported by the display 260 and a function performed by an application executed by the electronic device 202. For example, when the display 260 supports displaying the first luminance that is the maximum luminance of the HDR10+ video and the function performed by the application executed by the electronic device 202 allows the reproduction of a video in an HDR10+ format, the electronic device 202 may reproduce the HDR10+ video in the HDR10+ format on the display 260. In another example, when the display 260 does not support displaying the first luminance that is the maximum luminance of the HDR10+ video, the electronic device 202 may reproduce the HDR10+ video in a format different from the HDR10+ on the basis of the maximum luminance supported by the display 260. For example, when the maximum luminance that can be displayed by the display 260 is higher than the second luminance, the electronic device 202 may convert the HDR10+ video into a video having the second luminance as the maximum luminance on the basis of HDR10+ tone mapping and reproduce the converted video on the display 260. Alternatively, when the maximum luminance that can be displayed by the display 260 is lower than the second luminance and higher than the third luminance, the electronic device 202 may convert the HDR10+ video into a video having the third luminance as the maximum luminance on the basis of SDR tone mapping and reproduce the converted video on the display 260. In another example, when the application executed by the electronic device 202 displays an SDR video or a still image together with the HDR10+ video, the electronic device 202 may convert the HDR10+ video to have an SDR format corresponding to the SDR video or a display format corresponding to the still image and reproduce the converted video on the display 260. In another example, when the application executed by the electronic device 202 does not support the reproduction of the HDR10+ video, the electronic device 202 may convert the HDR10+ video to have a display format supported by the application and reproduce the converted video on the display 260. In another example, when the application executed by the electronic device 202 performs a function displaying a still image such as capturing a video and a displaying a thumbnail, the electronic device 202 may convert the HDR10+ video to have the SDR format corresponding to the SDR video and reproduce the converted video on the display 260.

According to various embodiments, the electronic device 202 may identify the HDR10+ video, the HDR10+ metadata, and the SDR metadata from the HDR10+ video clip 203 by using the HEVC decoder 240. According to various embodiments, when the HDR10+ video clip 203 further includes scene metadata, the electronic device 202 may identify the scene metadata by using the HEVC decoder 240.

According to various embodiments, when the HDR10+ video is reproduced in the HDR10+ format, the electronic device 202 may reproduce the HDR10+ video on the display 260 without reference to the HDR10+ metadata and the SDR metadata.

According to various embodiments, when the HDR10+ video is converted into the video having the second luminance as the maximum luminance and then reproduced, the electronic device 202 may identify the HDR10+ tone mapping function by parsing the HDR10+ metadata, as indicated by reference numeral 251. The electronic device 202 may perform the HDR10+ tone mapping 252 of converting the HDR10+ video into the video having the second luminance as the maximum luminance on the basis of the identified HDR10+ tone mapping function. The electronic device 202 may reproduce the video having the second luminance as the maximum luminance on the display 260.

According to various embodiments, when the HDR10+ video is converted into the video having the third luminance as the maximum luminance and then reproduced, the electronic device 202 may identify the SDR tone mapping function by parsing the SDR metadata, as indicated by reference numeral 254. The electronic device 202 may perform the SDR tone mapping 255 by converting the HDR10+ video into the video having the third luminance as the maximum luminance on the basis of the identified SDR tone mapping function. The electronic device 202 may reproduce the video having the third luminance as the maximum luminance on the display 260.

According to various embodiments, the electronic device 202 may identify the device computing power 253 of the electronic device 202 (i.e., a number of instructions per second that a processor of the electronic device 202 can perform) and perform the SDR tone mapping 255 on the basis of the identified computing power.

According to various embodiments, when the HDR10+ video clip 203 further includes scene metadata, the electronic device 202 may apply the same SDR tone mapping function to frames included in the same scene on the basis of the scene metadata when the device computing power 253 of the electronic device 202 is low and apply different SDR tone mapping functions to frames included in the same scene when the device computing power 253 of the electronic device 202 is high. When the computing power 253 of the electronic device 202 is greater than or equal to a threshold value, the electronic device 202 identifies that the computing power 253 of the electronic device 202 is high. When the computing power 253 of the electronic device 202 is not greater than or equal to a threshold value, the electronic device 202 identifies that the computing power 253 of the electronic device 202 is low.

According to various embodiments, when the HDR10+ video clip 203 further includes a plurality of pieces of scene metadata, the electronic device 202 may adopt scene metadata indicating that the number of scenes included in the HDR10+ video is relatively small when the device computing power 253 is low, adopt scene metadata indicating that the number of scenes is relatively large when the device computing power 253 is high, and apply the same SDR tone mapping function to frames included in the same scene on the basis of the adopted scene metadata.

According to various embodiments, when SDR metadata indicates a plurality of Bezier curves having different degrees for one frame, the electronic device 202 may apply a Bezier curve having a low degree as the SDR tone mapping function to perform the SDR tone mapping 255 when the device computing power 253 is low and apply a Bezier curve having a high degree as the SDR tone mapping function to perform the SDR tone mapping 255 when the device computing power 253 is high.

FIG. 3 illustrates operations performed by an electronic device which encodes a video according to various embodiments. In operation 310, at least one processor (for example, the processor 120) of an electronic device (for example, the electronic device 101) may acquire a first video having a first luminance as the maximum luminance through at least one camera (for example, the camera module 180). According to various embodiments, the first video may be an HDR10+ video and the first luminance may be 1000 cd/m².

In operation 320, at least one processor (for example, the processor 120) of the electronic device (for example, the electronic device 101) may identify a first tone mapping function for converting the first video into a second video having a second luminance that is lower than the first luminance as the maximum luminance. According to various embodiments, the second luminance may be 400 cd/m². According to various embodiments, the first tone mapping functions may be defined individually for a plurality of frames included in the first video.

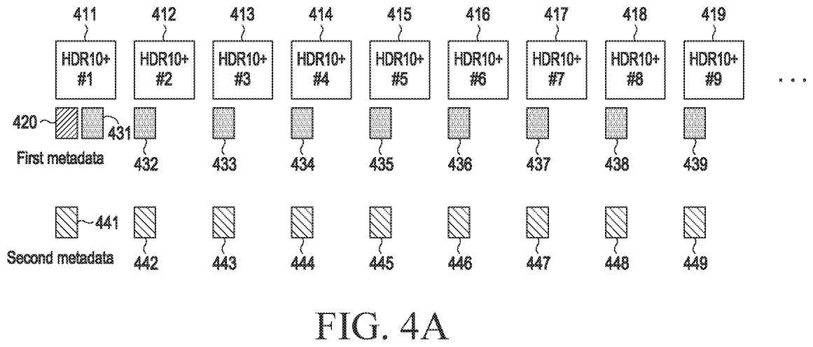

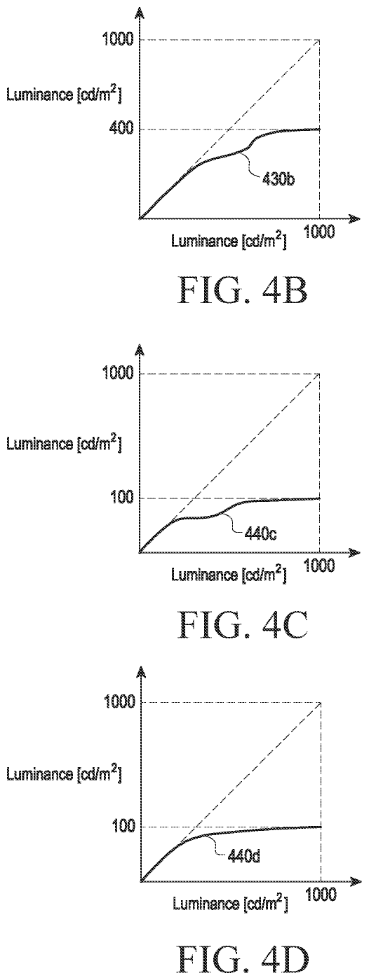

FIG. 4A illustrates metadata corresponding to the first video according to various embodiments. Referring to FIG. 4A, the first video may be a video in the HDR10+ format and may include a plurality of frames 411, 412, 413, 414, 415, 416, 417, 418, and 419. The first metadata may include static metadata 420 and dynamic metadata 431, 432, 433, 434, 435, 436, 437, 438, and 439. According to various embodiments, the static metadata 420 may be static metadata defined in SMPTE 2086. When the first video is reproduced by a device supporting video reproduction in the HDR10+ format, the reproducing device may reproduce the first video with reference to the static metadata 420.

As illustrated in FIG. 4A, according to various embodiments, the dynamic metadata 431, 432, 433, 434, 435, 436, 437, 438, and 439 may indicate individually defined first tone mapping functions in accordance with the plurality of frames 411, 412, 413, 414, 415, 416, 417, 418, and 419 included in the first video.

An example of the first tone mapping function according to various embodiments is illustrated in FIG. 4B. The horizontal axis of FIG. 4B indicates the luminance of the first video and the vertical axis of FIG. 4B indicates the luminance of the second video acquired through conversion of the first video according to a first tone mapping function 430b. Referring to FIG. 4B, the second video having a luminance range from 0 cd/m² to 400 cd/m² may be acquired through conversion of the first video having a luminance range from 0 cd/m² to 1000 cd/m² by the first tone mapping function 430b,

Referring back to FIG. 3, in operation 330, at least one processor (for example, the processor 120) of the electronic device (for example, the electronic device 101) may identify a second tone mapping function for converting the first video into a third video having a third luminance that is lower than the second luminance as the maximum luminance. According to various embodiments, the third luminance may be 100 cd/m². According to various embodiments, the third video may be a video in the SDR format.

Referring back to FIG. 4A, according to various embodiments, second metadata 441, 442, 443, 444, 445, 446, 447, 448, and 449 may indicate individually defined second tone mapping functions in accordance with a plurality of frames 411, 412, 413, 414, 415, 416, 417, 418, and 419 included in the first video. According to various embodiments, some of the second tone mapping functions corresponding to the second metadata 441, 442, 443, 444, 445, 446, 447, 448, and 449 may be the same as each other. The electronic device 101 may identify a change of motion through the scene change detection 224 and, when the change of motion identified in accordance with adjacent frames 411 and 412 is smaller than a predefined level, configure the second metadata 442 corresponding to the following frame 412 to be the same as the second metadata 441 corresponding to the previous frame 411.

An example of the second tone mapping function according to various embodiments is illustrated in FIGS. 4C and 4D. The horizontal axis of FIGS. 4C and 4D indicate the luminance of the first video and the vertical axis of FIGS. 4C and 4D indicate the luminance of the third video acquired through conversion of the first video according to second tone mapping functions 440c and 440d. Referring to FIGS. 4C and 4D, the third video having a luminance range from 0 cd/m² to 100 cd/m² may be acquired through conversion of the first video having a luminance range from 0 cd/m² to 1000 cd/m² by the second tone mapping functions 440c and 440d. According to various embodiments, the second mapping function may be the same as the second tone mapping function 440c or may be the same as the second tone mapping function 440d which is further simplified than the second tone mapping function 440c. According to various embodiments, at least one processor (for example, the processor 120) of the electronic device (for example, the electronic device 101) may identify the second tone mapping function in the form of the second tone mapping function 440c or the second tone mapping function 440d in consideration of the computing power of the electronic device 101.

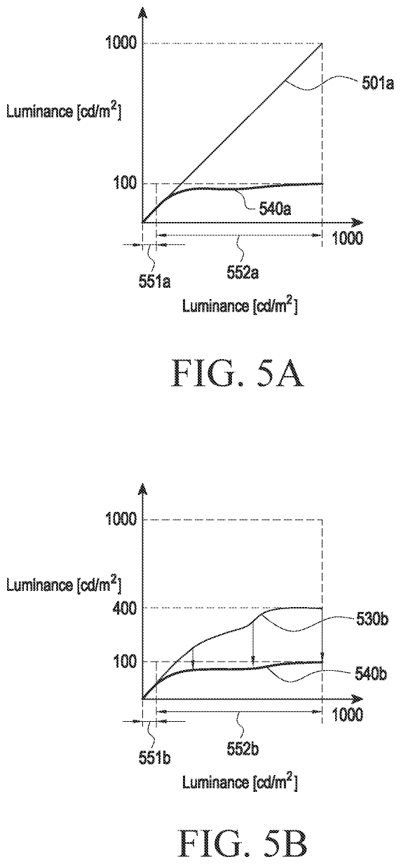

FIGS. 5A and 5B illustrate examples of a method of generating a second tone mapping function according to various embodiments. Referring to FIG. 5A, according to various embodiments, a second tone mapping function 540a may be identified by applying a method that is the same as the method of identifying the first tone mapping function (for example, the first tone mapping function 430b) and applying the third luminance instead of the second luminance. Referring to FIG. 5A, the second tone mapping function 540a may be a Bezier curve generated on the basis of histogram analysis of the first video.

According to various embodiments, the second tone mapping function 540a may be a function of increasing the luminance in a first interval 551a than that before conversion 501a and decreasing the luminance in a second interval 552a than that before conversion 501a. According to various embodiments, the second tone mapping function 540a may be a function of making a change in luminance in the first interval 551a relatively small and making a change in luminance in the second interval 552a relatively large.

Referring to FIG. 5B, according to various embodiments, the second tone mapping function 540b may be identified by linearly scaling or non-linearly scaling the first tone mapping function 530b.

According to various embodiments, the second tone mapping function 540b may be a function of increasing the luminance in the first interval 551a than that before conversion and decreasing the luminance in the second interval 552b than that before conversion. According to various embodiments, the second tone mapping function 540b may be a function of making a change in luminance in the first interval 551b relatively small and making a change in luminance in the second interval 552b relatively large.

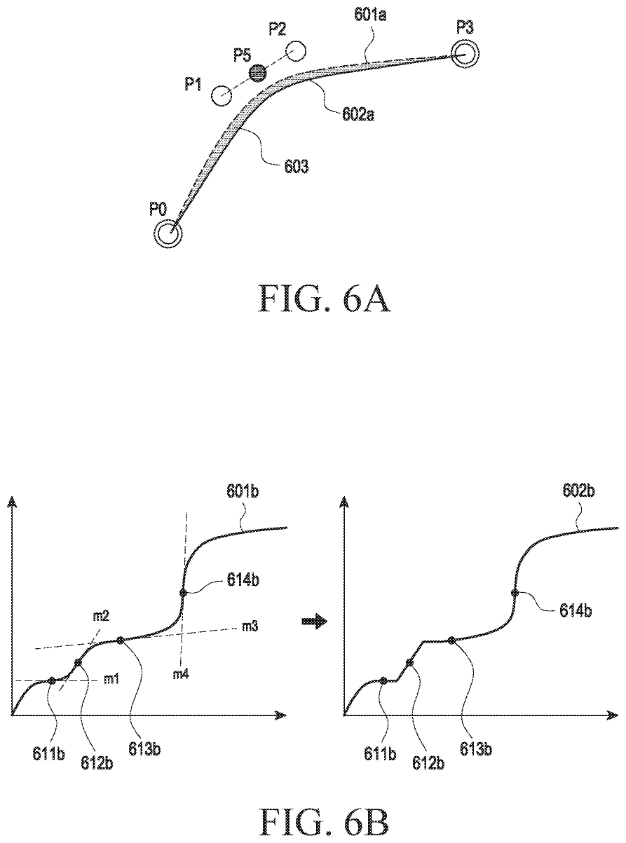

According to various embodiments, the second tone mapping function may be further simplified. FIGS. 6A and 6B illustrate examples of a method of simplifying a second tone mapping function according to various embodiments.

Referring to FIG. 6A, a method of identifying a third tone mapping function by decreasing a degree of the second tone mapping function which is a Bezier curve is illustrated. An (N−1)^{th}-degree Bezier curve 601a may be identified by replacing two adjacent anchor points P1 and P2 having the Euclidian distance shorter than a preset distance among anchor points P0, P1, P2, and P3 of an N-degree Bezier curve 602a with a middle point P5 of the two anchor points P1 and P2. A distortion error 603 may be generated by replacing the N^{th}-degree Bezier curve 602a with the (N−1)^{th}-degree Bezier curve 601a, but metadata corresponding to the third tone mapping function may be smaller than metadata corresponding to the second tone mapping function and tone mapping using the third tone mapping function may need less computing power than tone mapping using the second tone mapping function.

Referring to FIG. 6B, a method of identifying the third tone mapping function by linearly converting a part of the second tone mapping function which is a curve is illustrated. A second tone mapping function 601b may include a plurality of inflection points 611b, 612b, 613b, and 614b, and at least one processor 120 of the electronic device 101 may identify a plurality of straight lines m1, m2, m3, and m4 having the same slopes as the slopes of the second tone mapping function 601b at inflection points 611b, 612b, 613b, and 614b and having a plurality of inflection points 611b, 612b, 613b, and 614b. At least one processor 120 of the electronic device 101 may identify a simplified third tone mapping function 602b by replacing the second tone mapping function 601b with the plurality of straight lines m1, m2, m3, and m4 when the size of the distortion error generated when the second tone mapping function 601b is replaced with the plurality of straight lines m1, m2, m3, and m4 is smaller than a preset value.

For example, the size of the distortion error generated when the second tone mapping function 601b is replaced with the straight line m1 and the straight line m2 in an interval between the inflection point 611b and the inflection point 612b may be the same as an area defined by the straight line m1, the straight line m2, and the second tone mapping function 601b in the interval between the inflection point 611b and the inflection point 612b, and at least one processor 120 of the electronic device 101 may identify that the size of the distortion error in the interval between the inflection point 611b and the inflection point 612b is smaller than a preset value. As it is identified that the size of the distortion error in the interval between the inflection point 611b and the inflection point 612b is smaller than a preset value, at least one processor 120 of the electronic device 101 may identify the third tone mapping function 602b by replacing the second tone mapping function 601b in the interval between the inflection point 611b and the inflection point 612b with the straight line m1 and the straight line m2.

Similarly, the size of a distortion error generated when the second tone mapping function 601b is replaced with the straight line m2 and the straight line m3 in an interval between the inflection point 612b and the inflection point 613b may be the same as an area defined by the straight line m2, the straight line m3, and the second tone mapping function 601b in the interval between the inflection point 612b and the inflection point 613b, and at least one processor 120 of the electronic device 101 may identify that the size of the distortion error in an interval between the inflection point 612b and the inflection point 613b is smaller than a preset value. As it is identified that the size of the distortion error in the interval between the inflection point 612b and the inflection point 613b is smaller than a preset value, at least one processor 120 of the electronic device 101 may identify the third tone mapping function 602b by replacing the second tone mapping function 601b in the interval between the inflection point 612b and the inflection point 613b with the straight line m2 and the straight line m3.

Similarly, the size of a distortion error generated when the second tone mapping function 601b is replaced with the straight line m3 and the straight line m4 in an interval between the inflection point 613b and the inflection point 614b may be the same as an area defined by the straight line m3, the straight line m4, and the second tone mapping function 601b in the interval between the inflection point 613b and the inflection point 614b, and at least one processor 120 of the electronic device 101 may identify that the size of the distortion error in an interval between the inflection point 613b and the inflection point 614b is larger than a preset value. As it is identified that the size of the distortion error in the interval between the inflection point 613b and the inflection point 614b is larger than a preset value, at least one processor 120 of the electronic device 101 may identify that the third tone mapping function 602b is the same as the second tone mapping function 601b without replacing the second tone mapping function 601b in the interval between the inflection point 613b and the inflection point 614b with the straight line m3 and the straight line m4.

According to various embodiments, metadata corresponding to the third tone mapping function identified through simplifying the second tone mapping function may be smaller than metadata corresponding to the second tone mapping function, and tone mapping using the third tone mapping function may need less computing power than tone mapping using the second tone mapping function.

Referring back to FIG. 3, in operation 340, at least one processor (for example, the processor 120) of the electronic device (for example, the electronic device 101) may store first metadata based on the first tone mapping function and second metadata based on the second tone mapping function in a memory (for example, the memory 130) to be correlated with the first video. According to various embodiments, the first metadata and the second metadata may be stored in the user data space of the SEI. For example, the second metadata may be stored using HDR dynamic metadata syntax of ST 2094-40 described in CTA-861-G.

According to various embodiments, the first metadata may indicate the first tone mapping function. According to various embodiments, the second metadata may indicate the second tone mapping function. According to various embodiments, the second metadata may indicate the third tone mapping function identified through simplifying of the second tone mapping function. According to various embodiments, the second metadata may indicate the second tone mapping function and at least one third tone mapping function. When the second metadata indicates a plurality of functions, the second metadata may further include information on an amount of calculations required by the electronic device to reproduce the first video in accordance with the plurality of functions. The electronic device for reproducing the first video may perform tone mapping by using at least one of the plurality of functions indicated by the second metadata on the basis of information on the amount of calculations and its own computing power.

According to various embodiments, when the second metadata indicates the third tone mapping function identified by decreasing the degree of the second tone mapping function, the electronic device for reproducing the first video may identify the second tone mapping function by increasing the degree of the third tone mapping function identified on the basis of the second metadata and perform tone mapping for the first video by using the second tone mapping function when its own computing power is high enough to perform tone mapping using the second tone mapping function.

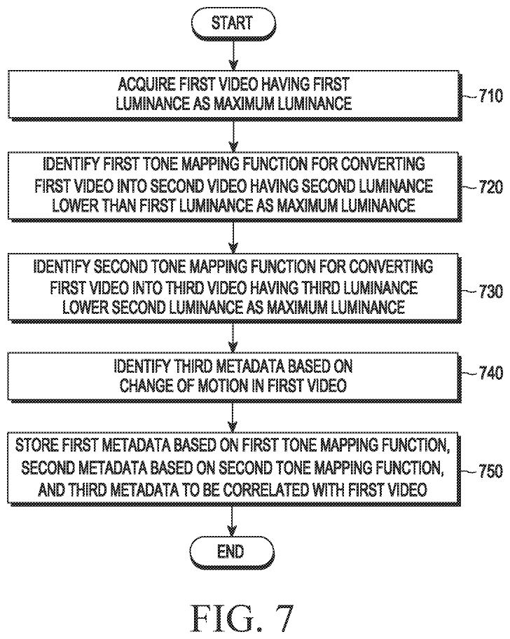

FIG. 7 illustrates operations performed by an electronic device which encodes a video according to various embodiments.

In operation 710, at least one processor (for example, the processor 120) of an electronic device (for example, the electronic device 101) may acquire a first video having a first luminance as the maximum luminance through at least one camera (for example, the camera module 180). The detailed description of operation 310 may be equally applied to operation 710.

In operation 720, at least one processor (for example, the processor 120) of an electronic device (for example, the electronic device 101) may identify a first tone mapping function for converting the first video into a second video having a second luminance that is lower than the first luminance as the maximum luminance. The detailed description of operation 320 may be equally applied to operation 720.

In operation 730, at least one processor (for example, the processor 120) of the electronic device (for example, the electronic device 101) may identify a second tone mapping function for converting the first video into a third video having a third luminance that is lower than the second luminance as the maximum luminance. The detailed description of operation 330 may be equally applied to operation 730.

In operation 740, at least one processor (for example, the processor 120) of the electronic device (for example, the electronic device 101) may identify third metadata based on a change of motion of the first video. According to various embodiments, the processor 120 may perform the scene change detection 224 to identify third metadata indicating a frame corresponding to a scene change among a plurality of frames within the first video on the basis of a change in frame images of the first video.

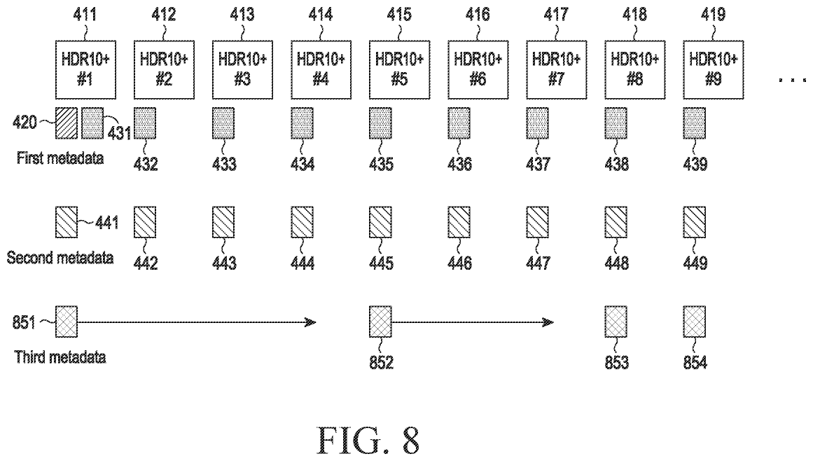

According to various embodiments, the third metadata may indicate a boundary of frames dividing scenes. Referring to FIG. 8, third metadata 851, 852, 853, and 854 may indicate frames starting new scenes. According to various embodiments, the third metadata may not only indicate the boundary of the frames dividing the scenes but also further include additional information on scenes.

According to various embodiments, at least one processor 120 may identify a resource condition such as computing power and/or the memory of the electronic device 101 and differently configure the third metadata on the basis of the identified resource condition. As described above with reference to the scene change detection 224, at least one processor 120 may identify the third metadata to categorize frames into different scenes even though a change of motion between the frames is small when the resource condition of the electronic device 101 is good and categorize frames into the same scene even though a change of motion between the frames is large when resources of the electronic device 101 are lacking. In other words, at least one processor 120 may identify the third metadata to make the number of scenes included in the first video relatively large when the resource condition of the electronic device 101 is good and make the number of scenes included in the first video relatively small when resources of the electronic device 101 are lacking.

According to various embodiments, at least one processor 120 may identify a plurality of pieces of third metadata having different numbers of scenes. Referring back to FIG. 8, the third metadata 851, 852, 853, and 854 may categorize a first frame 411 to a fourth frame 414, a fifth frame 415 to a seventh frame 417, and an eighth frame 418, and a ninth frame 419 into different scenes. At least one processor 120 may further identify third metadata (not shown) of categorizing the first frame 411 to the seventh frame 417 into one scene and the eighth frame 418 and the ninth frame 419 into another scene as well as the third metadata 851, 852, 853, and 854 illustrated in FIG. 8. At least one processor 120 may identify a scene change coefficient value corresponding to a plurality of pieces of third metadata. According to various embodiments, a high scene change coefficient value may indicate that there are lots of scene changes and the number of scenes included in the video is relatively large.

In operation 750, at least one processor (for example, the processor 120) of the electronic device (for example, the electronic device 101) may store first metadata based on the first tone mapping function, second metadata based on the second tone mapping function, and third metadata in a memory (for example, the memory 130) to be correlated with the first video. The detailed description of the first metadata and the second metadata that has been made for operation 340 may be equally applied to operation 750.

According to various embodiments, at least one processor 120 may store a third metadata file that is correlated with the first video or may store a plurality of pieces of third metadata to be correlated with the first video. According to various embodiments, when the plurality of pieces of third metadata are stored to be correlated with the first video, at least one processor 120 may further store a scene change coefficient value corresponding to the plurality of pieces of third metadata.

According to various embodiments, the electronic device for reproducing the first video may convert the first video by applying the same second tone mapping function to frames included in the same scene on the basis of the third metadata 851, 852, 853, and 854 instead of applying different second tone mapping functions to respective frames on the basis of the second metadata 441, 442, 443, 444, 445, 446, 447, 448, and 449.

According to various embodiments, the electronic device for reproducing the first video may use one piece of third metadata among the plurality of pieces of third metadata in consideration of calculation resources such as its own computing power. For example, the electronic device for reproducing the first video may use a plurality of pieces of third metadata corresponding to a large scene change coefficient when calculation resources are good and use a plurality of pieces of third metadata corresponding to a small scene change coefficient when calculation resources are lacking.

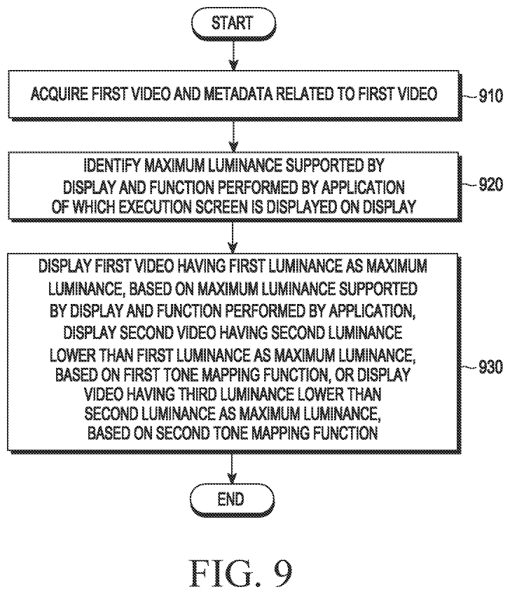

FIG. 9 illustrates operations performed by an electronic device which decodes a video according to various embodiments. In operation 910, at least one processor (for example, the processor 120) of the electronic device (for example, the electronic device 101) may acquire a first video and metadata related to the first video. According to various embodiments, the metadata related to the first video may include first metadata and second metadata. According to various embodiments, the metadata related to the first video may include first metadata, second metadata, and third metadata.

In operation 920, at least one processor (for example, the processor 120) of the electronic device (for example, the electronic device 101) may identify the maximum luminance supported by a display (for example, the display module 160) and a function performed by an application of which an execution screen is displayed on the display 160.

In operation 930, at least one processor (for example, the processor 120) of the electronic device (for example, the electronic device 101) may display the first video having a first luminance as the maximum luminance on the display 160 on the basis of the maximum luminance supported by the display (for example, the display module 160) and the function performed by the application, display a second video having a second luminance that is lower than the first luminance as the maximum luminance on the basis of a first tone mapping function, or display a video having a third luminance that is lower than the second luminance as the maximum luminance on the basis of a second tone mapping function.

According to various embodiments, a display format of the video displayed by at least one processor 120 may be limited by the maximum luminance supported by the display 160. For example, when the maximum luminance supported by the display 160 is lower than the second luminance, at least one processor 120 may not display a video in a display format having the first luminance or the second luminance as the maximum luminance on the display 160 and may display a video in a display format having the third luminance as the maximum luminance. In another example, when the maximum luminance supported by the display 160 is higher than or equal to the second luminance and lower than the first luminance, at least one processor 120 may not display the first video in a display format having the first luminance as the maximum luminance on the display 160 and may display a video in a display format having the second luminance or the third luminance as the maximum luminance. Alternatively, when the maximum luminance supported by the display 160 is higher than or equal to the first luminance, at least one processor 120 may display a video in a display format having the first luminance as the maximum luminance on the display 160.

According to various embodiments, a display format of the video displayed by at least one processor 120 may be limited by the function performed by the application of which the execution screen is displayed on the display 160. For example, when the function currently performed by the application includes not only displaying the first video having the first luminance as the maximum luminance but also displaying of a video or a still image having the third luminance as the maximum luminance, in other words, when the execution screen displayed on the display 160 includes not only the first video but also the video or the still image having the third luminance as the maximum luminance, at least one processor 120 may convert the first video into a display format having the third luminance as the maximum luminance and display the first video.

In another example, when the application of which the execution screen is displayed on the display 160 does not support the display format having the second luminance as the maximum luminance and the display format having the first luminance as the maximum luminance, at least one processor 120 may convert the first video into the display format having the third luminance as the maximum luminance and display the first video.

In another example, when the function currently performed by the application of which the execution screen is displayed on the display 160 corresponds to displaying a thumbnail of the first video having the first luminance as the maximum luminance or displaying a captured image of the first video, at least one processor 120 may convert a frame corresponding to the thumbnail or the captured image in the first video into the display format having the third luminance as the maximum luminance and display the frame as the thumbnail or the captured image.

According to various embodiments, at least one processor 120 may display a video according to a display format having a lower maximum luminance among a display format indicated by the maximum luminance supported by the display 160 and a display format indicated by the function performed by the application.

According to various embodiments, when the first video having the first luminance as the maximum luminance is displayed on the display 160, at least one processor 120 may display the first video without reference to first metadata, second metadata, or third metadata.

According to various embodiments, when the first video having the first luminance as the maximum luminance is displayed in the display format having the second luminance as the maximum luminance, at least one processor 120 may identify a first tone mapping function for converting the first video into a second video having the second luminance as the maximum luminance on the basis of the first metadata, convert the first video into the second video on the basis of the first tone mapping function, and display the second video on the display 160.

According to various embodiments, when the first video having the first luminance as the maximum luminance is displayed in the display format having the third luminance as the maximum luminance, at least one processor 120 may identify a second tone mapping function for converting the first video into a video having the third luminance as the maximum luminance on the basis of the second metadata, convert the first video into the video having the third luminance on the basis of the second tone mapping function, and display the converted video on the display 160.

According to various embodiments, when the first video is displayed in the display format having the third luminance as the maximum luminance, at least one processor 120 may identify a resource condition such as computing power of the electronic device 101 and/or memory resources and convert the first video by using different tone mapping functions on the basis of the resource condition. For example, at least one processor 120 may convert the first video into the video having the third luminance as the maximum luminance by using the second tone mapping function when resources of the electronic device 101 are good, and may convert the first video into the video having the third luminance as the maximum luminance by using a third tone mapping function identified through simplification of the second tone mapping function when resources of the electronic device 101 are lacking, and then display the converted video on the display 160.

According to various embodiments, when the first video is displayed in the display format having the third luminance as the maximum luminance, at least one processor 120 may convert the first video with further reference to third metadata indicating a frame corresponding to a scene change within the first video. At least one processor 120 may convert the first video into the video having the third luminance as the maximum luminance by using the same second tone mapping function for frames included in the same scene with reference to the third metadata and display the converted video on the display 160.

According to various embodiments, when the first video is displayed in the display format having the third luminance as the maximum luminance, at least one processor 120 may or may not further refer to the third metadata in consideration of the resource condition of the electronic device 101. For example, at least one processor 120 may convert the first video into the video having the third luminance as the maximum luminance by using the second tone mapping function differently defined for each frame when the resources of the electronic device 101 are good and may convert the first video into the video having the third luminance as the maximum luminance by using the same second tone mapping function for frames included in the same scene with reference to the third metadata when the resources of the electronic device 101 are lacking, and then display the converted video on the display 160.

According to various embodiments, when the first video is displayed in the display format having the third luminance as the maximum luminance and the third metadata is referred to, at least one processor 120 may convert the first video with reference to one of a plurality of pieces of third metadata in consideration of the resource condition of the electronic device 101. For example, at least one processor 120 may refer to the third metadata corresponding to a high scene change coefficient value among the plurality of pieces of third metadata when the resources of the electronic device 101 are good, refer to the third metadata corresponding to a low scene change coefficient value among the plurality of pieces of third metadata when the resources of the electronic device 101 are lacking, convert the first video into the video having the third luminance as the maximum luminance by using the same second tone mapping function for frames included in the same scene, and display the converted video on the display 160.

According to various embodiments, when the first video is displayed in the display format having the third luminance as the maximum luminance, at least one processor 120 may convert the first video into the video having the third luminance as the maximum luminance by using the same second tone mapping function for a plurality of frames in consideration of the resource condition of the electronic device 101 even though metadata related to the first video acquired in operation 910 does not include the third metadata. For example, when the resources of the electronic device 101 are lacking, at least one processor 120 may group a plurality of frames included in the first video in units of IDRs, convert the first video into the video having the third luminance as the maximum luminance by using the same second tone mapping function for frames included in the same group, and display the converted video on the display 160.

According to various embodiments, an electronic device (for example, the electronic device 101) may include at least one camera (for example, the camera module 180) and at least one processor (for example, the processor 120), and the at least one processor 120 may be configured to acquire a first video through the at least one camera (for example, the camera module 180), wherein a maximum luminance of the first video is a first luminance, identify a first tone mapping function for converting the first video into a second video, wherein a maximum luminance of the second video is a second luminance that is lower than the first luminance, identify a second tone mapping function for converting the first video into a third video, wherein a maximum luminance of the third video is a third luminance that is lower than the second luminance as the maximum luminance, and store first metadata, which is based on the first tone mapping function and second metadata, which is based on the second tone mapping function to be correlated with the first video.

According to various embodiments, the second tone mapping function may be defined individually for a plurality of frames included in the first video.

According to various embodiments, the at least one processor 120 may be configured to identify the second tone mapping function in a Bezier curve form, based on the third luminance and analysis of a histogram of the first video.

According to various embodiments, the at least one processor 120 may be configured to identify the second tone mapping function by non-linearly scaling the first tone mapping function.

According to various embodiments, the at least one processor 120 may be configured to identify a third tone mapping function for converting the first video into a fourth video by simplifying the second tone mapping function, and the second metadata may be identified based on the second tone mapping function and the third tone mapping function, wherein a maximum luminance of the fourth video is the third luminance that is lower than the second luminance.

According to various embodiments, the second metadata may include information on an amount of calculations corresponding to the second tone mapping function and the third tone mapping function.

According to various embodiments, the at least one processor 120 may be configured to identify third metadata indicating a frame corresponding to a scene change within the first video, based on an amount of change in frame images of the first video, and store the third metadata to be correlated with the first video.

According to various embodiments, the at least one processor 120 may be configured to identify a resource condition of the electronic device 101, and identify the third metadata, based on the resource condition.

According to various embodiments, the at least one processor 120 may be configured to identify a plurality of pieces of third metadata having different scene change coefficients, and store a plurality of scene change coefficients corresponding to the plurality of pieces of third metadata to correspond to the plurality of pieces of third metadata.

According to various embodiments, an electronic device (for example, the electronic device 101) may include a display (for example, the display module 160) and at least one processor (for example, the processor 120), and the at least one processor 120 may be configured to acquire a first video having a first luminance as a maximum luminance and metadata related to the first video, the metadata including first metadata indicating a first tone mapping function for converting the first video into a second video having a second luminance that is lower than the first luminance and second metadata indicating a second tone mapping function for converting the first video into a video having a third luminance that is lower than the second luminance as a maximum luminance, identify the maximum luminance supported by the display and a function performed by an application of which an execution screen is displayed on the display, display the first video on the basis of the maximum luminance supported by the display and the function performed by the application, display the second video on the basis of the first tone mapping function, or display a video having the third luminance as the maximum luminance on the basis of the second tone mapping function.

According to various embodiments, the second metadata may further indicate a third tone mapping function for converting the first video into a video having the third luminance as the maximum luminance, and the at least one processor 120 may be configured to identify a resource condition of the electronic device 101, perform tone mapping for the first video, based on the second tone mapping function according to the resource condition, perform tone mapping for the first video, based on the third tone mapping function, and display the video having the third luminance as the maximum luminance, based on the tone mapping for the first video as a part of an operation of displaying the video having the third luminance as the maximum luminance, based on the maximum luminance supported by the display and the function performed by the application.

According to various embodiments, the metadata may include a plurality of pieces of third metadata indicating a frame corresponding to a scene change within the first video, the plurality of pieces of third metadata may correspond to different scene change coefficients, and the at least one processor 120 may identify a resource condition of the electronic device 101, performing tone mapping for the first video, based on one piece of third metadata identified based on the resource condition among the plurality of pieces of third metadata and second metadata, and display the video having the third luminance as the maximum luminance, based on the tone mapping for the first video as a part of an operation of displaying the video having the third luminance as the maximum luminance, based on the maximum luminance supported by the display and the function performed by the application.

According to various embodiments, a method performed by an electronic device (for example, the electronic device 101) may include an operation of acquiring a first video through at least one camera (for example, the camera module 180) of the electronic device 101, wherein a maximum luminance of the first video is a first luminance, an operation of identifying a first tone mapping function for converting the first video into a second video, wherein a maximum luminance of the second video is a second luminance that is lower than the first luminance, an operation of identifying a second tone mapping function for converting the first video into a third video, wherein a maximum luminance of the third video is a third luminance that is lower than the second luminance, and an operation of storing first metadata, which is based on the first tone mapping function and second metadata, which is based on the second tone mapping function to be correlated with the first video.

According to various embodiments, the second tone mapping function may be defined individually for a plurality of frames included in the first video.

According to various embodiments, the operation of identifying the second tone mapping function may include an operation of identifying the second tone mapping function in a Bezier curve form, based on the third luminance and analysis of a histogram of the first video.

According to various embodiments, the operation of identifying the second tone mapping function may include an operation of non-linearly scaling the first tone mapping function.

According to various embodiments, the method may further include an operation of identifying a third tone mapping function for converting the first video into a third video by simplifying the second tone mapping function, wherein a maximum luminance of the fourth video is the third luminance that is lower than the second luminance, and the second metadata may be identified based on the second tone mapping function and the third tone mapping function.

According to various embodiments, the method may further include an operation of identifying third metadata indicating a frame corresponding to a scene change within the first video, based on an amount of change in frame images of the first video, and an operation of storing the third metadata to be correlated with the first video.

According to various embodiments, the method may further include an operation of identifying a resource condition of the electronic device 101, and the operation of identifying the third metadata may be performed based on the resource condition.

According to various embodiments, the operation of identifying the third metadata may include an operation of identifying a plurality of pieces of third metadata having different scene change coefficients, and the method may further include an operation of storing a plurality of scene change coefficients corresponding to the plurality of pieces of third metadata to correspond to the plurality of pieces of third metadata.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
at least one camera; and
at least one processor,
wherein the at least one processor is configured to:
acquire a first video through the at least one camera, wherein a maximum luminance of the first video is a first luminance,
identify a first tone mapping function for converting the first video into a second video, wherein a maximum luminance of the second video is a second luminance that is lower than the first luminance,
identify a second tone mapping function for converting the first video into a third video, wherein a maximum luminance of the third video is a third luminance that is lower than the second luminance, and
store first metadata, which is based on the first tone mapping function and second metadata, which is based on the second tone mapping function to be correlated with the first video.

2. The electronic device of claim 1, wherein the second tone mapping function is defined individually for a plurality of frames included in the first video.

3. The electronic device of claim 1, wherein the at least one processor is further configured to identify the second tone mapping function in a Bezier curve form, based on the third luminance and analysis of a histogram of a maximum value among an R value, a G value, and a B value for a plurality of frames included in the first video.

4. The electronic device of claim 1, wherein the at least one processor is further configured to identify the second tone mapping function by non-linearly scaling the first tone mapping function.

5. The electronic device of claim 1, wherein the at least one processor is further configured to identify a third tone mapping function for converting the first video into a fourth video by simplifying the second tone mapping function, wherein a maximum luminance of the fourth video is the third luminance that is lower than the second luminance, and
the second metadata is identified based on the second tone mapping function and the third tone mapping function.

6. The electronic device of claim 5, wherein the second metadata comprises information on an amount of calculations corresponding to the second tone mapping function and the third tone mapping function.

7. The electronic device of claim 1, wherein the at least one processor is further configured to:
identify third metadata indicating a frame corresponding to a scene change within the first video, based on an amount of change in frame images of the first video, and
store the third metadata to be correlated with the first video.

8. The electronic device of claim 7, wherein the at least one processor is further configured to:
identify a resource condition of the electronic device, and
identify the third metadata, based on the resource condition.

9. The electronic device of claim 7, wherein the at least one processor is further configured to:
identify a plurality of pieces of third metadata having different scene change coefficients, and
store a plurality of scene change coefficients corresponding to the plurality of pieces of third metadata to correspond to the plurality of pieces of third metadata.

10. A method performed by an electronic device, the method comprising:
acquiring a first video through at least one camera of the electronic device, wherein a maximum luminance of the first video is a first luminance;
identifying a first tone mapping function for converting the first video into a second video, wherein a maximum luminance of the second video is a second luminance that is lower than the first luminance;
identifying a second tone mapping function for converting the first video into a third video, wherein a maximum luminance of the third video is a third luminance that is lower than the second luminance; and
storing first metadata, which is based on the first tone mapping function and second metadata, which is based on the second tone mapping function to be correlated with the first video.

11. The method of claim 10, wherein the second tone mapping function is defined individually for a plurality of frames included in the first video.

12. The method of claim 10, wherein the identifying of the second tone mapping function comprises identifying the second tone mapping function in a Bezier curve form, based on the third luminance and analysis of a histogram of the first video.

13. The method of claim 10, wherein the identifying of the second tone mapping function comprises non-linearly scaling the first tone mapping function.

14. The method of claim 10, further comprising identifying a third tone mapping function for converting the first video into the third video by simplifying the second tone mapping function, wherein a maximum luminance of the fourth video is the third luminance that is lower than the second luminance,
wherein the second metadata is identified based on the second tone mapping function and the third tone mapping function.

15. The method of claim 10, further comprising:
identifying third metadata indicating a frame corresponding to a scene change within the first video, based on an amount of change in frame images of the first video, and
storing the third metadata to be correlated with the first video.

16. The method of claim 15, further comprising:
identifying a resource condition of the electronic device, and
identifying the third metadata, based on the resource condition.

17. The method of claim 15, further comprising:
identifying a plurality of pieces of third metadata having different scene change coefficients, and
storing a plurality of scene change coefficients corresponding to the plurality of pieces of third metadata to correspond to the plurality of pieces of third metadata.

18. An electronic device comprising:
a display; and
at least one processor,
wherein the at least one processor is configured to:
acquire a first video having a first luminance as a maximum luminance and metadata related to the first video, wherein the metadata includes first metadata indicating a first tone mapping function for converting the first video into a second video having a second luminance that is lower than the first luminance, and second metadata indicating a second tone mapping function for converting the first video into a video having a third luminance that is lower than the second luminance as a maximum luminance,
identify maximum luminance supported by the display and a function performed by an application of which an execution screen is displayed on the display, and
display the first video based on the maximum luminance supported by the display and the function performed by the application, or display the second video based on the first tone mapping function, or display a video having the third luminance as the maximum luminance based on the second tone mapping function.

19. The electronic device of claim 18, wherein the at least one processor is further configured to:
wherein the second metadata further indicates a third tone mapping function for converting the first video into a video having the third luminance as the maximum luminance,
identify a resource condition of the electronic device,
perform tone mapping for the first video based on the second tone mapping function according to the resource condition, or perform tone mapping for the first video based on the third tone mapping function, and
display the video having the third luminance as the maximum luminance, based on the tone mapping for the first video as a part of an operation of displaying the video having the third luminance as the maximum luminance, based on the maximum luminance supported by the display and the function performed by the application.

20. The electronic device of claim 18,
wherein the metadata includes a plurality of pieces of third metadata indicating a frame corresponding to a scene change within the first video, and the plurality of pieces of third metadata correspond to different scene change coefficients,
wherein the at least one processor is further configured to:
identify a resource condition of the electronic device,
perform tone mapping for the first video based on one piece of third metadata identified based on the resource condition among the plurality of pieces of third metadata, and second metadata, and
display a video having the third luminance as the maximum luminance, based on the tone mapping for the first video.
